(19) United States
(12) Patent Application Publication
(10) Pub. No.: US 2002/0082838 A1
(43) Pub. Date: Jun. 27, 2002

(54) Voice communication concerning a local entity

(76) Inventors: Stephen John Hinde, Bristol (GB); Lawrence Wilcock, Malmesbury (GB); Paul St John Brittan, Claverham (GB); Guillaume Belrose, Bristol (GB)

Correspondence Address: Ross A. Schmitt, c/o LADAS & PARRY, Suite 2100, 5670 Wilshire Boulevard, Los Angeles, CA, 90036-5679, US

(21) Appl. No.: 09/990,764

(22) Filed: Nov. 21, 2001

(30) Foreign Application Priority Data
Nov. 25, 2000 (GB) 0028775.5

(51) Int. Cl. G10L 21/00; G10L 11/00

(52) U.S. Cl. 704/270.1

(57) ABSTRACT

A local entity without its own means of voice communication is provided with the semblance of having a voice interaction capability. This is done by detecting the location of a user wishing to communicate with such entities, and comparing the user's location with the known locations of entities having associated voice services. The voice services are separately hosted from the entities themselves. Upon the user being determined to be close to a voice-enabled entity, contact is initiated between the user and the voice service associated with the local entity; for example, contact data for the voice service is passed to user equipment from where it is sent to a network voice browser and used by the latter to contact the voice service. The user then interacts with the voice service, the latter acting as a voice proxy for the local entity with voice output from the service being controlled to appear to emanate from the local entity.

### FIELD OF THE INVENTION

The present invention relates to voice services and in particular, but not exclusively, to a method of providing for voice interaction with a local dumb device.

### BACKGROUND OF THE INVENTION

In recent years there has been an explosion in the number of services available over the World Wide Web on the public internet (generally referred to as the “web”), the web being composed of a myriad of pages linked together by hyperlinks and delivered by servers on request using the HTTP protocol. Each page comprises content marked up with tags to enable the receiving application (typically a GUI browser) to render the page content in the manner intended by the page author; the markup language used for standard web pages is HTML (HyperText Markup Language).

However, today far more people have access to a telephone than have access to a computer with an Internet connection. Sales of cellphones are outstripping PC sales so that many people have already or soon will have a phone within reach where ever they go. As a result, there is increasing interest in being able to access web-based services from phones. ‘Voice Browsers’ offer the promise of allowing everyone to access web-based services from any phone, making it practical to access the Web any time and any where, whether at home, on the move, or at work.

Voice browsers allow people to access the Web using speech synthesis, pre-recorded audio, and speech recognition. FIG. 1 of the accompanying drawings illustrates the general role played by a voice browser. As can be seen, a voice browser is interposed between a user 2 and a voice page server 4. This server 4 holds voice service pages (text pages) that are marked-up with tags of a voice-related markup language (or languages). When a page is requested by the user 2, it is interpreted at a top level (dialog level) by a dialog manager 7 of the voice browser 3 and output intended for the user is passed in text form to a Text-To-Speech (TTS) converter 6 which provides appropriate voice output to the user. User voice input is converted to text by speech recognition module 5 of the voice browser 3 and the dialog manager 7 determines what action is to be taken according to the received input and the directions in the original page. The voice input/output interface can be supplemented by keypads and small displays.

In general terms, therefore, a voice browser can be considered as a largely software device which interprets a voice markup language and generate a dialog with voice output, and possibly other output modalities, and/or voice input, and possibly other modalities (this definition derives from a working draft, dated September 2000, of the Voice browser Working Group of the World Wide Web Consortium).

Voice browsers may also be used together with graphical displays, keyboards, and pointing devices (e.g. a mouse) in order to produce a rich “multimodal voice browser”. Voice interfaces and the keyboard, pointing device and display maybe used as alternate interfaces to the same service or could be seen as being used together to give a rich interface using all these modes combined.

Some examples of devices that allow multimodal interactions could be multimedia PC, or a communication appliance incorporating a display, keyboard, microphone and speaker/headset, an in car Voice Browser might have display and speech interfaces that could work together, or a Kiosk.

Some services may use all the modes together to provide an enhanced user experience, for example, a user could touch a street map displayed on a touch sensitive display and say “Tell me how I get here?”. Some services might offer alternate interfaces allowing the user flexibility when doing different activities. For example while driving speech could be used to access services, but a passenger might used the keyboard.

FIG. 2 of the accompanying drawings shows in greater detail the components of an example voice browser for handling voice pages 15 marked up with tags related to four different voice markup languages, namely:

tags of a dialog markup language that serves to specify voice dialog behaviour;

tags of a multimodal markup language that extends the dialog markup language to support other input modes (keyboard, mouse, etc.) and output modes (large and small screens);

tags of a speech grammar markup language that serve to specify the grammar of user input; and

tags of a speech synthesis markup language that serve to specify voice characteristics, types of sentences, word emphasis, etc.

When a page 15 is loaded into the voice browser, dialog manager 7 determines from the dialog tags and multimodal tags what actions are to be taken (the dialog manager being programmed to understand both the dialog and multimodal languages 19). These actions may include auxiliary functions 18 (available at any time during page processing) accessible through APIs and including such things as database lookups, user identity and validation, telephone call control etc. When speech output to the user is called for, the semantics of the output is passed, with any associated speech synthesis tags, to output channel 12 where a language generator 23 produces the final text to be rendered into speech by text-to-speech converter 6 and output to speaker 17. In the simplest case, the text to be rendered into speech is fully specified in the voice page 15 and the language generator 23 is not required for generating the final output text; however, in more complex cases, only semantic elements are passed, embedded in tags of a natural language semantics markup language (not depicted in FIG. 2) that is understood by the language generator. The TTS converter 6 takes account of the speech synthesis tags when effecting text to speech conversion for which purpose it is cognisant of the speech synthesis markup language 25.

User voice input is received by microphone 16 and supplied to an input channel of the voice browser. Speech recogniser 5 generates text which is fed to a language understanding module 21 to produce semantics of the input for passing to the dialog manager 7. The speech recogniser 5 and language understanding module 21 work according to specific lexicon and grammar markup language 22 and, of course, take account of any grammar tags related to the current input that appear in page 15. The semantic output to the dialog manager 7 may simply be a permitted input word or may be more complex and include embedded tags of a natural language semantics markup language. The dialog manager 7 determines what action to take next (including, for example, fetching another page) based on the received user input and the dialog tags in the current page 15.

Any multimodal tags in the voice page 15 are used to control and interpret multimodal input/output. Such input/output is enabled by an appropriate recogniser 27 in the input channel 11 and an appropriate output constructor 28 in the output channel 12.

Whatever its precise form, the voice browser can be located at any point between the user and the voice page server. FIGS. 3 to 5 illustrate three possibilities in the case where the voice browser functionality is kept all together; many other possibilities exist when the functional components of the voice browser are separated and located in different logical/physical locations.

In FIG. 3, the voice browser 3 is depicted as incorporated into an end-user system 8 (such as a PC or mobile entity) associated with user 2. In this case, the voice page server 4 is connected to the voice browser 3 by any suitable data-capable bearer service extending across one or more networks 9 that serve to provide connectivity between server 4 and end-user system 8. The data-capable bearer service is only required to carry text-based pages and therefore does not require a high bandwidth.

FIG. 4 shows the voice browser 3 as co-located with the voice page server 4. In this case, voice input/output is passed across a voice network 9 between the end-user system 8 and the voice browser 3 at the voice page server site. The fact that the voice service is embodied as voice pages interpreted by a voice browser is not apparent to the user or network and the service could be implemented in other ways without the user or network being aware.

In FIG. 5, the voice browser 3 is located in the network infrastructure between the end-user system 8 and the voice page server 4, voice input and output passing between the end-user system and voice browser over one network leg, and voice-page text data passing between the voice page server 4 and voice browser 3 over another network leg. This arrangement has certain advantages; in particular, by locating expensive resources (speech recognition, TTS converter) in the network, they can be used for many different users with user profiles being used to customise the voice-browser service provided to each user.

A more specific and detailed example will now be given to illustrate how voice browser functionality can be differently located between the user and server. More particularly, FIG. 6 illustrates the provision of voice services to a mobile entity 40 which can communicate over a mobile communication infrastructure with voice-based service systems 4, 61. In this example, the mobile entity 40 communicates, using radio subsystem 42 and a phone subsystem 43, with the fixed infrastructure of a GSM PLMN (Public Land Mobile Network) 30 to provide basic voice telephony services. In addition, the mobile entity 40 includes a data-handling subsystem 45 interworking, via data interface 44, with the radio subsystem 42 for the transmission and reception of data over a data-capable bearer service provided by the PLMN; the data-capable bearer service enables the mobile entity 40 to access the public Internet 60 (or other data network). The data handling subsystem 45 supports an operating environment 46 in which applications run, the operating environment including an appropriate communications stack.

Considering the FIG. 6 arrangement in more detail, the fixed infrastructure 30 of the GSM PLMN comprises one or more Base Station Subsystems (BSS) 31 and a Network and Switching Subsystem NSS 32. Each BSS 31 comprises a Base Station Controller (BSC) 34 controlling multiple Base Transceiver Stations (BTS) 33 each associated with a respective “cell” of the radio network. When active, the radio subsystem 42 of the mobile entity 20 communicates via a radio link with the BTS 33 of the cell in which the mobile entity is currently located. As regards the NSS 32, this comprises one or more Mobile Switching Centers (MSC) 35 together with other elements such as Visitor Location Registers 52 and Home Location Register 52.

When the mobile entity 40 is used to make a normal telephone call, a traffic circuit for carrying digitised voice is set up through the relevant BSS 31 to the NSS 32 which is then responsible for routing the call to the target phone whether in the same PLMN or in another network such as PSTN (Public Switched Telephone Network) 56.

With respect to data transmission to/from the mobile entity 40, in the present example three different data-capable bearer services are depicted though other possibilities exist. A first data-capable bearer service is available in the form of a Circuit Switched Data (CSD) service; in this case a full traffic circuit is used for carrying data and the MSC 35 routes the circuit to an InterWorking Function IWF 54 the precise nature of which depends on what is connected to the other side of the IWF. Thus, IWF could be configured to provide direct access to the public Internet 60 (that is, provide functionality similar to an LAP—Internet Access Provider IAP). Alternatively, the IWF could simply be a modem connecting to PSTN 56; in this case, Internet access can be achieved by connection across the PSTN to a standard IAP.

A second, low bandwidth, data-capable bearer service is available through use of the Short Message Service that passes data carried in signalling channel slots to an SMS unit 53 which can be arranged to provide connectivity to the public Internet 60.

A third data-capable bearer service is provided in the form of GPRS (General Packet Radio Service which enables IP (or X.25) packet data to be passed from the data handling system of the mobile entity 40, via the data interface 44, radio subsystem 41 and relevant BSS 31, to a GPRS network 37 of the PLMN 30 (and vice versa). The GPRS network 37 includes a SGSN (Serving GPRS Support Node) 38 interfacing BSC 34 with the network 37, and a GGSN (Gateway GPRS Support Node) interfacing the network 37 with an external network (in this example, the public Internet 60). Full details of GPRS can be found in the ETSI (European Telecommunications Standards Institute) GSM 03.60 specification. Using GPRS, the mobile entity 40 can exchange packet data via the BSS 31 and GPRS network 37 with entities connected to the public Internet 60.

The data connection between the PLMN 30 and the Internet 60 will generally be through a gateway 55 providing functionality such as firewall and proxy functionality.

Different data-capable bearer services to those described above may be provided, the described services being simply examples of what is possible. Indeed, whilst the above description of the connectivity of a mobile entity to resources connected to the communications infrastructure, has been given with reference to a PLMN based on GSM technology, it will be appreciated that many other cellular radio technologies exist (for example, UTMS, CDMA etc.) and can typically provide equivalent functionality to that described for the GSM PLMN 30.

The mobile entity 40tself may take many different forms. For example, it could be two separate units such as a mobile phone (providing elements 42-44) and a mobile PC (providing the data-handling system 45), coupled by an appropriate link (wireline, infrared or even short range radio system such as Bluetooth). Alternatively, mobile entity 40 could be a single unit.

FIG. 6 depicts both a voice page server 4 connected to the public internet 60 and a voice-based service system 61 accessible via the normal telephone links.

The voice-based service system 61 is, for example, a call center and would typically be connected to the PSTN 56 and be accessible to mobile entity 40 via PLMN 30 and PSTN 56. The system 56 could also (or alternatively) be connected directly to the PLMN though this is unlikely. The voice-based service system 61 includes interactive voice response units implemented using voice pages interpreted by a voice browser 3A. Thus a user can user mobile entity 40 to talk to the service system 61 over the voice circuits of the telephone infrastructure; this arrangement corresponds to the situation illustrated in FIG. 4 where the voice browser is co-located with the voice page server.

If, as shown, the service system 61 is also connected to the public internet 60 and is enabled to receive VoIP (Voice over IP) telephone traffic, then provided the data handling subsystem 45 of the mobile entity 40 has VoIP functionality, the user could use a data capable bearer service of the PLMN 30 of sufficient bandwidth and QoS (quality of service) to establish a VoIP call, via PLMN 30, gateway 55, and internet 60, with the service system 61.

With regard to access to the voice services embodied in the voice pages held by voice page server 4 connected to the public internet 60, if the data-handling subsystem of the mobile entity is equipped with a voice browser 3E, then all that the mobile entity need do to use these services is to establish a data-capable bearer connection with the voice page server 4 via the PLMN 30, gateway 55 and internet 60, this connection then being used to carry the text based request response messages between the server 61 and mobile entity 4. This corresponds to the arrangement depicted in FIG. 3.

PSTN 56 can be provisioned with a voice browser 3B at internet gateway 57 access point. This enables the mobile entity to place a voice call to a number that routes the call to the voice browser and then has the latter connect to the voice page server 4 to retrieve particular voice pages. Voice browser then interprets these pages back to the mobile entity over the voice circuits of the telephone network. In a similar manner, PLMN 30 could also be provided with a voice browser at its internet gateway 55. Again, third party service providers could provide voice browser services 3D accessible over the public telephone network and connected to the internet to connect with server 4. All these arrangements are embodiments of the situation depicted in FIG. 5 where the voice browser is located in the communication network infrastructure between the user end system and voice page server.

It will be appreciated that whilst the foregoing description given with respect o FIG. 6 concerns the use of voice browsers in a cellular mobile network environment, voice browsers are equally applicable to other environments with mobile or static connectivity to the user.

Voice-based services are highly attractive because of their ease of use; however, they do require significant functionality to support them. For this reason, whilst it is desirable to provide voice interaction capability for many types of devices in every day use, the cost of doing so is currently prohibitive.

It is an object of the present invention to provide a method and apparatus by which entities can be given a voice interface simply and at low cost. As will be seen, the method and apparatus of the invention depend on user location determination. Techniques for effecting location determination are, of course, well known and the Appendix to this specification reviews some of these techniques with reference to FIGS. 7 to 10 of the accompanying drawings.

### SUMMARY OF THE INVENTION

According to one aspect of the present invention, there is provided a system for enabling verbal communication on behalf of a local entity with a nearby user, the system comprising:

location determining means for determining the location of the user,

comparison means for comparing the location of the user with the known locations of entities having associated voice services, these voice services being separately hosted from the entities themselves;

a communications infrastructure;

audio output means operatively connected to the communication infrastructure and either forming part of equipment carried by the user or located in the locality of said local entity;

a voice service arrangement for providing said voice service, the voice service arrangement being connected to said communications infrastructure; and

service initiation means, responsive to the comparison means determining that the user is close to a said entity, to initiate, automatically or under user control, voice service delivery by the voice service arrangement via the communications infrastructure and

the audio output means with the voice service acting as voice proxy for the local entity; the audio output means comprising multiple sound output devices spaced from the local entity, and means for controlling their sound output such that output from the voice service appears to the user to emanate from said local entity.

According to another aspect of the present invention, there is provided a method of voice communication concerning a local entity wherein:

(a) the location of a user is determined and compared with the known locations of entities having associated voice services, these voice services being separately hosted from the entities themselves;

(b) upon the user being determined to be close to a said entity, contact is initiated between the user and the voice service associated with the local entity; and

(c) the user interacts with the voice service with the latter acting as voice proxy for the local entity, voice output from the service being through audio output devices spaced from the local entity but controlled such that the service output appears to the user to emanate from that entity.

### BRIEF DESCRIPTION OF THE DRAWINGS

A method and apparatus embodying the invention, for location-triggered communication with a dumb entity, will now be described, by way of non-limiting example, with reference to the accompanying diagrammatic drawings, in which:

FIG. 1 is a diagram illustrating the role of a voice browser;

FIG. 2 is a diagram showing the functional elements of a voice browser and their relationship to different types of voice markup tags;

FIG. 3 is a diagram showing a voice service implemented with voice browser functionality located in an end-user system;

FIG. 4 is a diagram showing a voice service implemented with voice browser functionality co-located with a voice page server;

FIG. 5 is a diagram showing a voice service implemented with voice browser functionality located in a network between the end-user system and voice page server;

FIG. 6 is a diagram of a mobile entity accessing voice services via various routes through a communications infrastructure including a PLMN, PSTN and public internet;

FIG. 7 is a diagram illustrating one known approach to determining the location of a mobile entity, this approach involving providing the entity with an inertial positioning system;

FIG. 8 is a diagram illustrating another known approach to determining the location of a mobile entity, this approach being based on proximity of the mobile entity to fixed-position local beacons;

FIG. 9 is a diagram illustrating a further known approach to determining the location of a mobile entity, this approach involving the use of GPS satellites;

FIG. 10 is a diagram illustrating a still further approach to determining the location of a mobile entity, this approach being based on the use of signals present in a cellular mobile radio communications system;

FIG. 11 is a diagram of a first embodiment of the invention in which a mobile phone is used for accessing a remote voice page server;

FIG. 12 is a diagram of a second embodiment of the invention involving a home server system; and

FIG. 13 is a functional block diagram of an audio-field generating apparatus;

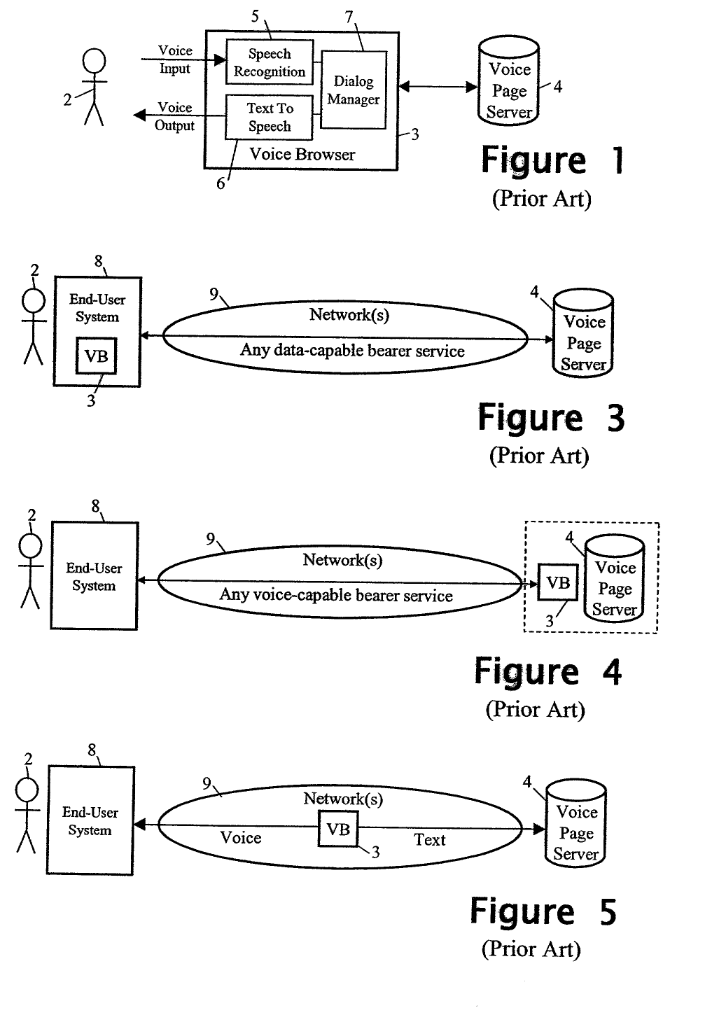

### BEST MODE OF CARRYING OUT THE INVENTION

In the following description, voice services are described based on voice page servers serving pages with embedded voice markup tags to voice browsers. Unless otherwise indicated, the foregoing description of voice browsers, and their possible locations and access methods is to be taken as applying also to the described embodiments of the invention. Furthermore, although voice-browser based forms of voice services are preferred, the present invention in its widest conception, is not limited to these forms of voice service system and other suitable systems will be apparent to persons skilled in the art.

The embodiments of the invention to be described below involve determining the location of a user. As will be apparent to persons skilled in the art, any suitable location determining mechanism can be used for this purpose including the systems described in the Appendix to this specification.

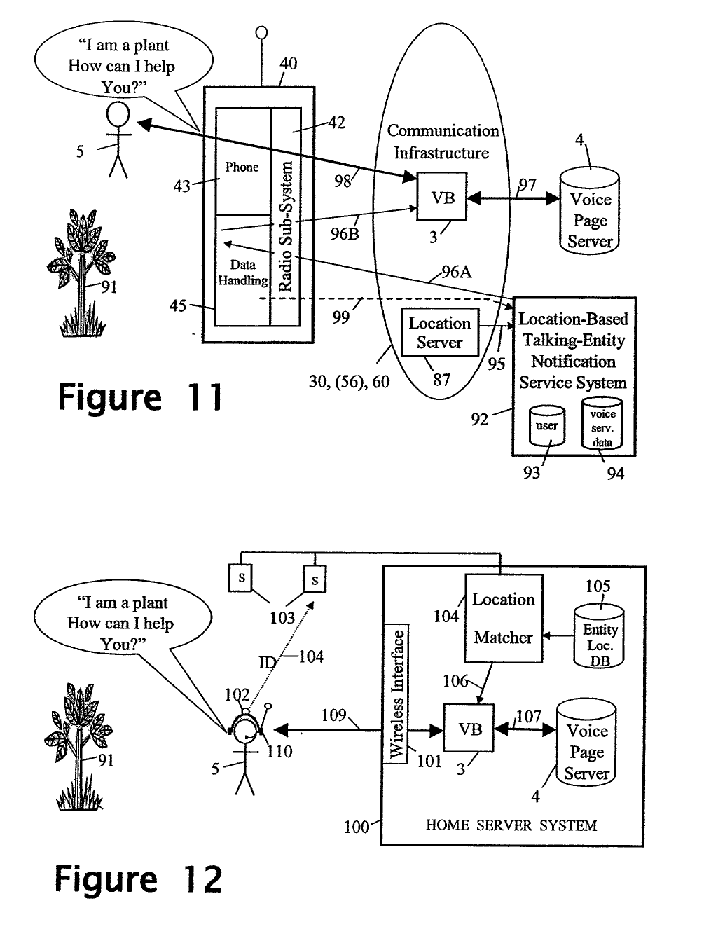

In both embodiments of the invention to be described below with references to FIGS. 11 and 12 respectively, a dumb entity (here a plant 91, but potentially any object, including a mobile object) is given a voice dialog capability by associating a voice service with the plant 91, this service being triggered, or its availability signalled, whenever the location of the user is determined to be near the plant 91. The voice service acts as a voice dialog proxy for the plant and gives the impression to the persons using the service that they are conversing with the plant.

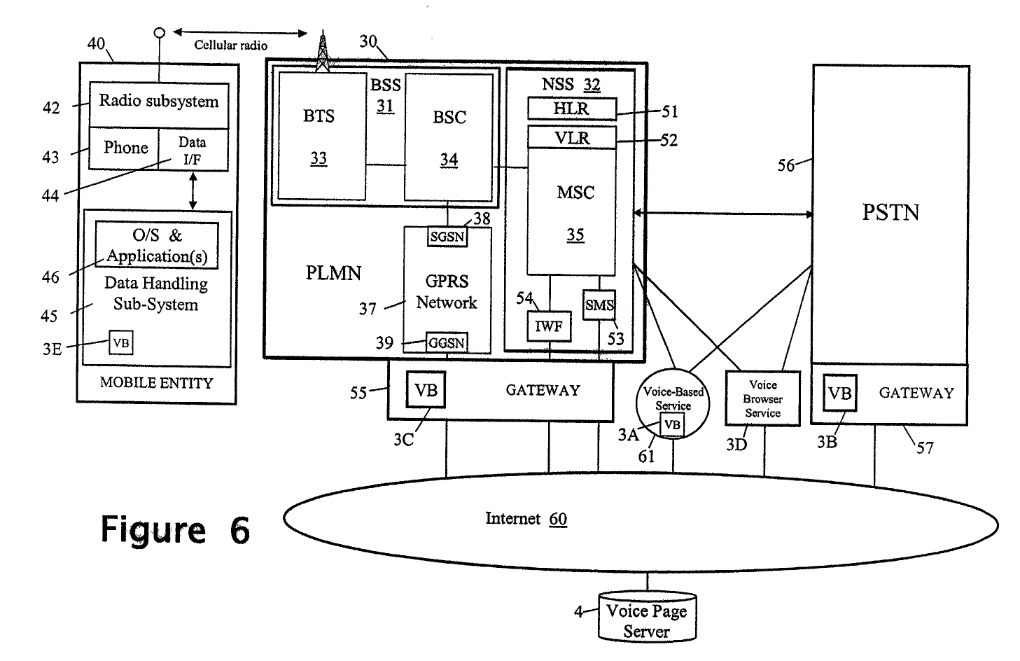

Considering the FIG. 11 embodiment in more detail, a user 5 is equipped with a mobile entity 40 similar to that of FIG. 6. The user is registered with a location-based talking-entity notification service system 92 accessible to the mobile entity 40 over a data-capable bearer connection passing via the communications infrastructure comprising the mobile network 30 and the internet 60 (potentially with the interposition of the public telephone network 56). The service system 92 stores user profile data in database 93 and voice service data in database 94, this voice service data comprising for each entity (such as plant 91) for which a voice service is available, contact data (such as URL) for the voice service and possibly data about the type of information provided by the voice service. In the present example, the voice services are provided by voice pages, that is, text based pages marked up with voice markup tags and intended to be interpreted into speech by a voice browser 3, shown in FIG. 3 as being part of the communications infrastructure, though other locations are possible.

The service system 92 is authorised by the user to request and receive location updates relating to the mobile entity 40 from a location server, here shown as a network-based location server 87 similar to that depicted in FIG. 10. The user activates the service system by an appropriate message passed over the data-capable bearer connection, thereby to permit the service system to receive continual updates, from location server 87, on the user's location. The service system compares the user's current location with the location of the voice-enabled entities listed in database 94 and when the user is within a specified range of an entity, a ‘hit’ is signalled. The service system 92 can be arranged to filter out ‘hits’ that relate to voice services of no interest to the user, as judged by the user-profile data held in database 93.

Upon a ‘hit’ being signalled in the service system, action is taken to inform the user who may then access the voice service concerned to talk to the corresponding entity local to the user—here, plant 91. This can be achieved in a number of ways, several of which are outlined below in items (A) to (D):

(A)—Contact data for the voice service is sent by the service system 92 to the mobile entity through the communications infrastructure over a data-capable bearer service (see arrow 96A). The contact data preferably includes information about the local entity and the voice service (as retrieved from database 94). An application running in the data-handling subsystem 45 of the mobile entity 40 receives the contact data and notifies the user 5 of this ‘hit’ through a user interface of the mobile entity 40. The user indicates whether or not the voice service is to be contacted. If the indication is positive, then voice contact is established with the voice service, for example in any of the following ways:

(i) The contact data is a URL specific to the voice service for the plant 91. This URL is passed by the mobile entity, together with the telephone number of the mobile entity 40, to the voice browser 3 over a data-capable bearer connection set up through the communication infrastructure from the mobile entity 40 to the voice browser 3. This results in the voice browser 3 calling back the mobile entity 40 to set up a voice circuit between them and, at the same time, the browser accesses the voice page server 4 to retrieve a first page of the voice service associated with the plant 91. This page (and any subsequent pages) are then interpreted by the voice browser with voice output being passed over the voice circuit to the phone subsystem 43 and thus to user 5, and voice input from the user being returned over the same circuit to the browser. This is the arrangement depicted by the arrows 96B, 97 and 98 in FIG. 11 with arrow 96B representing the initial contact passing the voice service URL and mobile entity number to the voice browser, arrow 97 depicting the exchange of request/response messages between the browser 3 and server 4, and arrow 98 representing the exchange of voice messages across the voice circuit between the voice browser 3 and phone subsystem of mobile entity 40. A variant of this arrangement is for the mobile entity to initially contact the voice page server directly, the latter then being responsible for contacting the voice browser and having the latter set up a voice circuit to the mobile entity.

(ii) The contact data is a URL specific to the voice service for the plant 91. This URL is passed by the mobile entity 40 to the voice browser 3 over a data capable bearer connection established through the communication infrastructure from the mobile entity 40 to the voice browser 3. The browser accesses the voice page server 4 to retrieve a first page of the voice service associated with the plant 91. This page (and any subsequent pages) are then interpreted by the voice browser with voice output being passed as VoIP data to the data-handling subsystem of the mobile entity 40 using the same data-capable bearer connection as used to pass the voice-service URL to the browser 3. Voice input from the user is returned over the same bearer connection to the browser.

(iii) The contact data is a telephone number specific to the voice service for the plant 91. This telephone number is used by the application running in the data handling subsystem 45 to cause the phone subsystem 43 to dial the number. This results in a voice circuit being set up to the voice browser 3 with the browser then accessing the voice page server 4 to retrieve a first page of the voice service associated with the plant 91. This page (and any subsequent pages) are then interpreted by the voice browser with voice output being passed over the voice circuit to the phone subsystem 43 and thus to user 5, and voice input from the user being returned over the same circuit to the browser.

Where the mobile entity 40 is itself equipped with a voice browser 3 then, of course, initial (and subsequent) voice pages can be fetched from the voice page server 4 over a data-capable bearer connection set up through the communications infrastructure. In this case, where resources (such as memory or processing power) at the mobile entity are restricted, the same connection can be used by the voice browser to access remote resources as may be needed, including the pulling in of appropriate lexicons and grammar specifications.

(B) Instead of the voice service contact data being sent to the mobile entity, only brief details of the local entity and related voice service are sent to the mobile entity over a data-capable bearer connection. As in (A), the user is asked to indicate whether or not the voice service is to be contacted. The user's response is returned to the service system 92 which, if the response is positive, is then responsible for instructing the voice browser 3 to retrieve voice pages from the voice page server for the relevant voice service and interpret these pages to the mobile entity over an appropriate connection. This latter connection can either be a data-capable bearer connection carrying VoIP or similar voice data packets, or a voice circuit established by telephoning the mobile entity (it being assumed that the telephone number of the mobile entity is known to the service system and passed to the voice browser 3). The voice browser 3 need not be located in the infrastructure and could conveniently be part of the service system 92 itself. The initial notification of the ‘hit’ that is sent to the user could be sent as a voice message over a voice circuit established between the service system 92 and the mobile entity 40, the notification being, for example, a marked-up voice page interpreted by a voice browser 3 in the service system or the communications infrastructure.

A variant on the above is for the service system to send the contact data for the voice service to the voice browser 3 at the same time as notifying the user of the ‘hit’. The notification would also include the address of the voice browser and an identifier associated with the voice service details of the ‘hit’. In this case, when the user gives a positive indicates they want to listen to the voice service, mobile entity 40 contacts the voice browser, sending the identifier thereby enabling the voice browser to access the desired voice service.

(C) The contact data of the voice service, in the form of a URL, is sent to the voice browser 3 together with any other available information about the voice service and contact details for the mobile entity (either a telephone number or data address). The voice browser is then responsible for notifying the user of the voice service ‘hit’ and acting upon a positive response from the user, to access the voice service and interpret the voice pages to the user (voice connectivity between the voice browser and user being established in any of the ways already indicated above). Instead of the user contact data being a telephone number or data address, it could take the form of a user identifier which the voice browser uses to look up an access number or address of the user's equipment using a user database associated with the voice browser or some other element of the communications infrastructure.

(D) Contact data for the user is sent to the voice service at the voice page server 4 and the latter is responsible for contacting the user (which will generally be done via a network voice browser 3 unless the mobile entity 40 is itself provided with voice browser functionality). Contact with a network voice browser is made over a data connection whereas contact with the mobile entity 40 from the browser 3 will either be via voice circuit or a data-capable bearer connection carrying VoIP packets or equivalent.

Of course, the step of notifying the user of a ‘hit’ and ascertaining whether or not they wish to access the voice service concerned can be skipped, the contact data (and any other necessary data) being sent directly to the voice browser 3 for immediate action to access the voice service and establish voice contact with the user. In contrast, rather than the user's location being determined on a continuous basis and ‘hits’ being continuously looked for, user-location determination and ‘hit’ determination could be carried out by the service system 92 on a one-off basis only when specifically asked for by the user (as indicated by dashed arrow 99 in FIG. 11).

The nature of the voice service and, in particular the dialog followed, will of course, depend on the nature of the dumb entity being given a voice capability. In the present case of a plant 91, the dialog may be directed at informing the user about the plant and its general needs.

The FIG. 12 embodiment concerns a restricted environment (here taken to be a home environment but potentially any other proprietary space such as an office or similar) where a home server system 100 includes a voice page server 4 and associated voice browser 3, the latter being connected to a wireless interface 101 to enable it to communicate with devices in the home over a home wireless network.

The home is equipped with means for determining the location of identified individuals at least in terms of the room they are in. In the illustrated embodiment, these means comprise infrared sensors 103 arranged to pick up user identity signals emitted (arrow 104) from an infrared beacon 102 carried by each home occupant—in FIG. 12 the user 5 is shown as carrying beacon 102 on a wireless headset 110. Any other suitable location-determining means can be used and the location resolution can, with current technology, be made much more accurate than simple room location, as will be appreciated by persons skilled in the art.

The sensors 103 pass user location information to location matcher 104 which is part of the home server system, the information being passed by a wired network or by using the home wireless radio network. This location information will typically comprise the identity of the user and the identity of the sensor 3 picking up the user ID; the location matcher is programmed with the location of each sensor 3 and thus can determine the location of the identified user. The location matcher 104 has an associated store 105 holding data about each dumb entity (such as plant 91) which has an associated voice service; this data comprises the location of the entity in the home and the URL on voice page server 4 of the corresponding voice service home page.

The location matcher 104 compares the sensor-detected location of user 5 with the entity location data held in store 105 and when the user moves close to one of these entities (e.g. plant 91), a ‘hit’ is determined and the URL of the corresponding voice service is output (arrow 106) to the voice browser 3. This results in the browser 3 accessing the voice page server 4 to retrieve a first page of the voice service associated with the plant 91. This page (and any subsequent pages) are then interpreted by the voice browser with voice output being passed over the home wireless network to the wireless headset 110 of the user (see arrow 109); voice input from the user 5 is returned over the wireless network to the browser.

Rather than the user being spoken to every time they come close to a voice-enabled entity, the voice browser could simply “bleep” to the user when they moved close to such an entity. The browser would then await a response from the user indicating that they desired to hear from the entity concerned before accessing the corresponding voice pages from server 4. An alternative approach is to have user control activation of the infrared beacon 102 which, instead of transmitting user ID continuously, would only do so when activated by the user; the user would then only active the beacon 102 when they wished to talk to a nearby entity.

As with the FIG. 11 embodiment, the voice browser could be incorporated in equipment carried by the user.

Variants

Many variants are, of course, possible to the arrangements described above with reference to FIGS. 11 and 12. For example, with respect to the FIG. 11 embodiment, location determination could be done at the mobile entity 40 (using, for example, a GPS system) or else the location server could be arranged to supply the location information to the mobile entity rather than the service system. The user can then either control the sending of their location data to the service system or can effect location matching in the mobile entity itself, the service system simply being periodically asked to provide location data about dumb entities within the general locality of the user. Whatever the case, location matching will typically be limited to a user-entity range corresponding to a distance over which the user could establish voice communication with the entity (were the dumb entity capable of it).

The identity of the user can be sent to the voice service itself and used by the latter to look up user profile data which is then used to customise the voice service to the user.

Rather than voice input and output being effected via the user equipment (mobile entity for the FIG. 11 embodiment, wireless headset 90 for the FIG. 12 embodiment), this can be done using local loudspeakers and microphones connected by wireline or by the wireless network with the voice browser. Alternatively, voice input and output can be differently implemented from each other with, for example, voice input being done using a microphone carried by the user and voice output done by local loudspeakers.

By having multiple local loudspeakers, and assuming that their locations relative to the plant 91 were known to the voice browser system or other means used to provide audio output control, the voice browser can control the volume from each speaker to make it appear as if the sound output was coming from the plant. This is particularly useful where there are multiple voice-enabled dumb entities in the same area.

A similar effect (making the voice output appear to come from the dumb entity) can also be achieved for users wearing stereo-sound headsets provided the following information is known to the voice browser (or other element responsible for setting output levels between the two stereo channels):

location of the user relative to the entity (this can be determined in any suitable manner including by using a sufficiently accurate location determining arrangement for fixing the position of the user, the location of the entity being fixed and known); and

the orientation of the user's head (determined, for example, using a magnetic flux compass or solid state gyros incorporated into the headset).

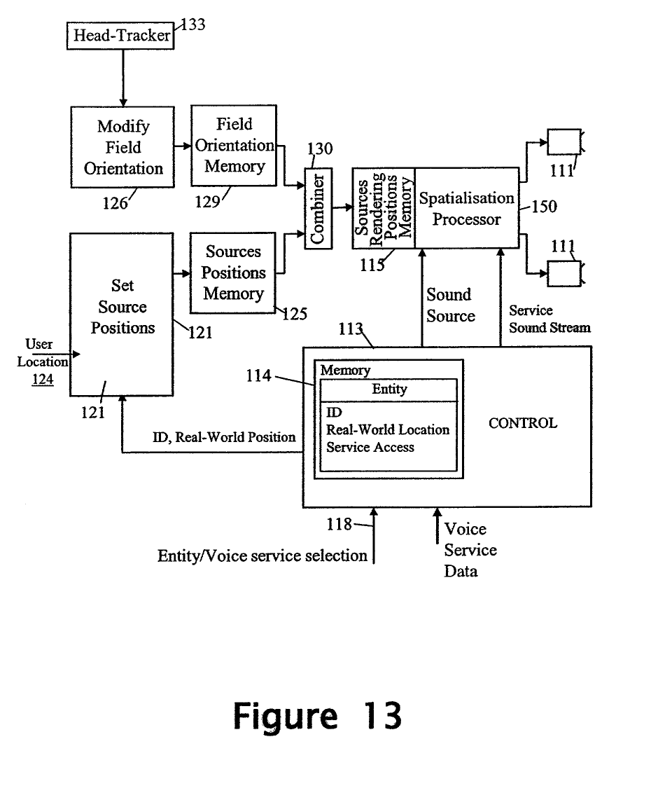

FIG. 13 shows apparatus that is operative to generate, through headphones, an audio field in which the voice service of a currently-selected local entity is presented through a synthesised sound source positioned in the audio field so as to appear to coincide (or line up) with the entity, the audio field being world-stabilised so that the entity-representing sound source does not rotate relative to the real world as the user rotates their head or body.

The heart of the apparatus is a spatialisation processor 150 which, given a desired audio-field rendering position and an input audio stream, is operative to produce appropriate signals for feeding to user-carried headphones 111 in order to generate the desired audio field. Such spatialisation processors are known in the art and will not be described further herein.

The FIG. 13 apparatus includes a control block 113 with memory 114. Dialog output is only permitted from one entity (or, rather, the associated voice service) at a time, the selected entity/voice service being indicated to the control block on input 1118. However, data on multiple local entities and their voice services can be held in memory, this data comprising for each entity: an ID, the real-world location of the entity (provided directly by that entity or from the associated voice service), and details of the associated voice service. For each entity for which data is stored in memory 114, a rendering position is determined for the sound source that is to be used to represent that entity in the audio field as and when that entity is selected.

The FIG. 13 apparatus works on the basis that the position of each entity-representing is specified relative to an audio-field reference vector, the orientation of which relative to a presentation reference vector can be varied to achieve the desired world stabilisation of the sound sources. The presentation reference vector corresponds, for a set of headphones, to the forward facing direction of the user and therefore changes its direction as the user turns their head. The user is at least notionally located at the origin of the presentation reference vector.

The spatialisation processor 150 uses the presentation reference vector as its reference so that the rendering positions of the sound sources need to be provided to the processor 150 relative to that vector. The rendering position of a sound source is thus a combination of the position of the source in the audio field judged relative to the audio-field reference vector, and the current rotation of the audio field reference vector relative to the presentation reference vector.

Because headphones worn by the user rotate with the user's head, the synthesised sound sources will also appear to rotate with the user unless corrective action is taken. In order to impart a world stabilisation to the sound sources, the audio field is given a rotation relative to the presentation reference vector that cancels out the rotation of the latter as the user turns their head. This results in the rendering positions of the sound sources being adjusted by an amount appropriate to keep the sound sources in the same perceived locations so far as the user is concerned. A suitable head-tracker sensor 133 (for example, an electronic compass mounted on the headphones) is provided to measure the azimuth rotation of the user's head relative to the world to enable the appropriate counter rotation to be applied to the audio field.

Referring again to FIG. 13, the determination of the rendering position of each entity-representing sound source in the output audio field is done by injecting a sound-source data item into a processing path involving elements 121 to 130. This sound-source data item comprises an entity/sound source ID and the real-world location of the entity (in any appropriate coordinate system. Each sound-source data item is passed to a set-source-position block 121 where the position of the sound source is automatically determined relative to the audio-field reference vector on the basis of the supplied position information.

The position of each sound source relative to the audio field reference vector is set such as to place the sound source in the field at a position determined by the associated real-world location and, in particular, in a position such that it lies in the same direction relative to the user as the associated real-world location. To this end, block 121 is arranged to receive and store the real-world locations passed to it from block 113, and also to receive the current location of the user as determined by any suitable means such as a GPS system carried by the user, or nearby location beacons. The block 121 also needs to know the real-world direction of pointing of the un-rotated audio-field reference vector (which, as noted above, is also the direction of pointing of the presentation reference vector). This can be derived for example, by providing a small electronic compass on the headphones 111 (this compass can also serve as the head tracker sensor 133 mentioned above); by noting the rotation angle of the audio-field reference vector at the moment the real-world direction of pointing of vector 44 is measured, it is then possible to derive the real-world direction of pointing of the audio-field reference vector.

The decided position for each source is then temporarily stored in memory 125 against the source ID.

Of course, as the user moves in space, the block 121 needs to reprocess its stored real-world location information to update the position of the corresponding sound sources in the audio field. Similarly, if updated real-world location information is received from a local entity, then the positioning of the sound source in the audio field must also be updated.

Audio-field orientation modify block 126 determines the required changes in orientation of the audio-field reference vector relative to presentation reference vector to achieve world stabilisation, this being done on the basis of the output of the afore-mentioned head tracker sensor 133. The required field orientation angle determined by block 126 is stored in memory 129.

Each source position stored in memory 125 is combined by combiner 130 with the field orientation angle stored in memory 129 to derive a rendering position for the sound source, this rendering position being stored, along with the entity/sound source ID, in memory 115. The combiner operates continuously and cyclically to refresh the rendering positions in memory 115.

The spatialisation processor 150 is informed by control block 113 which entity is currently selected (if any). Assuming an entity is currently selected, the processor 150 retrieves from memory 115 the rendering position of the corresponding sound source and then renders the sound stream of the associated voice service at the appropriate position in the audio field so that the output from the voice service appears to be coming from the local entity.

The FIG. 13 apparatus can be arranged to produce an audio field with one, two or three degrees of freedom regarding sound source location (typically, azimuth, elevation and range variations). Of course, audio fields with only azimuth variation over a limited arc can be produced by standard stereo equipment which may be adequate in some situations.

The FIG. 13 apparatus is primarily intended to be part of the user's equipment, being arranged to spatialize a selected voice service sound stream passed to the equipment either as digitised audio data or as text data for conversion at the equipment, via a text-to-speech converter, into a digitised audio stream. However, it is also possible to provide the apparatus remotely from the user, for example, at the voice browser, in which case the user is passed spatialised audio streams for feeding to the headphones.

Making the voice service output appear to come from the dumb entity itself as described above enhances the user experience of talking to the entity itself. It may be noted that this experience is different and generally superior to merely being provided with information in audio form about the entity (such as would occur with the audio rendering of a standard web page without voice mark up); instead, the present voice services enable a dialog between the user and the entity with the latter preferably being represented in first person terms.

Knowing the user's position or orientation relative to the entity also enables the voice service to be adapted accordingly. For example, a user approaching the back of an entity (typically not a plant) may receive a different voice output from the voice service as compared to a user approaching from the front. Similarly, a user facing away from the entity may be differently spoken to by the entity as compared to a user facing the entity. Also, a user crossing past the entity may be differently spoken to as compared to a user moving directly towards the entity or a user moving directly away from the entity (that is, the voice service is dependent on the user's ‘line of approach’—this term here being taken to include line of departure also). The user's position/orientation/line-of-approach relative to the entity can be used to adapt the voice service either on the basis of the user's initial position/orientation/approach to the entity or on an ongoing basis responsive to changes in the user's position/orientation/approach.

Where there are multiple voice-enabled dumb entities in the same area, the service system, voice browser, or equipment carried by the user, is preferably arranged to ignore new ‘hits’ if the user is still in dialog with another entity (in this respect, end of a dialog can be determined either as a sufficiently long pause by the user, a specific termination command from the user, or a natural end to the voice dialog script).

Other variants are also possible. For example, the user on contacting the voice service can be joined into a session with any other users currently using the voice service in respect of the same entity such that all users at least hear the same voice output of the voice service.

This can be achieved by functionality at the voice page server (session management being commonly effected at web page servers) but only to the level of what page is currently served to each user. It is therefore preferred to implement this common session feature at a voice browser thereby ensuring all users hear the same output at the same time. With respect to voice input by session members, there will generally be a need for the voice service to select one input stream in the case that more than one member speaks at the same time. The selected input voice stream can be relayed to other members by the voice browser to provide an indication as to what input is currently being handled; unselected input is not relayed in this manner.

An extension of this arrangement is to join the user into a session with any other users currently using the voice service in respect of the same local entity and other entities that have been logically associated with that entity, the voice inputs and outputs to and from the voice service being made available to all such users. Thus, if two similar plants that are not located near each other are logically associated, users in dialog with both plants are joined into a common session.

In another variant, the dumb entity is enabled to pass information about its state back to the voice service. This can be readily done where the dumb entity is already a network connected device (for example, a printer) but can also be achieved for entities such as plants by providing an associated network-connected device that is arranged to monitor the status of the entity. Entity state data can also be passed to the voice service via the user and their equipment by providing a short-range communication link (e.g. infrared, Bluetooth radio, etc) between the entity or associated device and the user equipment. The information about the current state of the dumb entity are stored by the voice service (for example, as session data either at the voice browser or voice page server) and enables the voice service to be conditioned to the state and needs of the plant.

The voice-enabled ‘dumb’ entity can be provided with associated functionality that is controlled by control data passed from the voice service via a network connection or a short-range link between the user equipment and the functionality. In the latter case, this control data is for example, scripted into the voice pages embedded in multimodal tags for extraction by the voice browser. The control data can be passed to the user's equipment from the voice service in a variety of ways depending in part whether or not the voice browser is located in the user equipment—if it is, then the control data is, of course, passed in the voice pages. If the voice browser is separate from the user equipment, then the control data can be embedded as audio signals in the voice output from the browser or communicated via a separate data channel.

Where the ‘dumb’ entity has an associated mouth-like feature movable by associated functionality, the control data from the voice service can be used to cause operation of the mouth-like device in synchronism with voice output from the voice service. Thus a dummy can be made to move its mouth in synchronism with dialog it is uttering via its associated voice service. This feature, which has application in museums and like attractions, is preferably used with the aforementioned arrangement of joining users in dialog with the same entity into a common session—since the dummy can only move its mouth in synchronism with one piece of dialog at a time, having all interested persons in the same session and selecting which user voice input is to be responded to, is clearly advantageous.

The mouth-like feature can be either physical in nature with actuators controlling movement of physical parts of the feature, or simply an electronically-displayed mouth (for example displayed on an LCD display). The coordination of the mouth-like feature with the voice service output aids people with hearing difficulties to understand what is being said.

Of course, as well as using multimodal tags for control data to be passed to the entity, more normal multimodal interactions (displays, keyboard, pointing devices etc.) can be scripted in the voice service provided by the voice page server in the embodiments of FIGS. 11 and 12.

Appendix—Location Determination

This Appendix forms an integral part of the specification.

Recently, much interest has been shown in “location-based”, “location-dependent”, or “location-aware” services for mobile users, these being services that take account of the current location of the user (or other mobile party). The most basic form of this service is the emergency location service whereby a user in trouble can press a panic button on their mobile phone to send an emergency request-for-assistance message with their location data appended. Another well known location-based service is the provision of traffic and route-guiding information to vehicle drivers based on their current position. The term “location-aware services” will be used herein to refer generically to these and similar services where a location dependency exists.

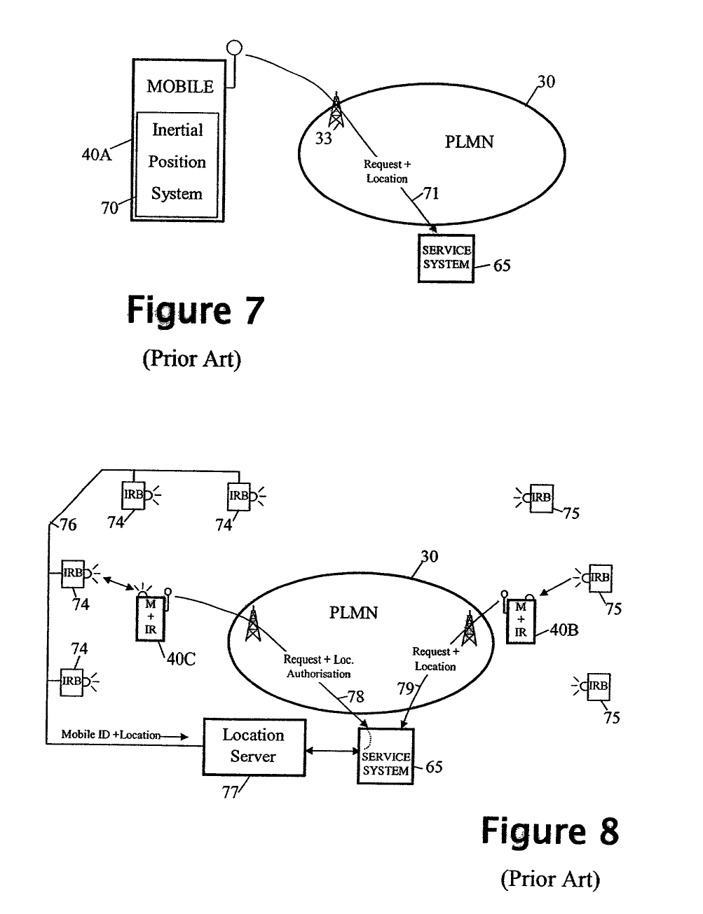

Location-aware services all require user location as an input parameter. A number of methods already exist for determining the location of a mobile user as represented by an associated mobile equipment. Example location-determining methods will now be described with reference to FIGS. 7 to 10. As will be seen, some of these methods result in the user knowing their location thereby enabling them to transmit it to a location-aware service they are interested in receiving, whilst other of the methods result in the user's location becoming known to a network entity from where it can be supplied directly to a location-aware service (generally only with the consent of the user concerned). It is to be understood that additional methods to those illustrated in FIGS. 7 to 10 exist.

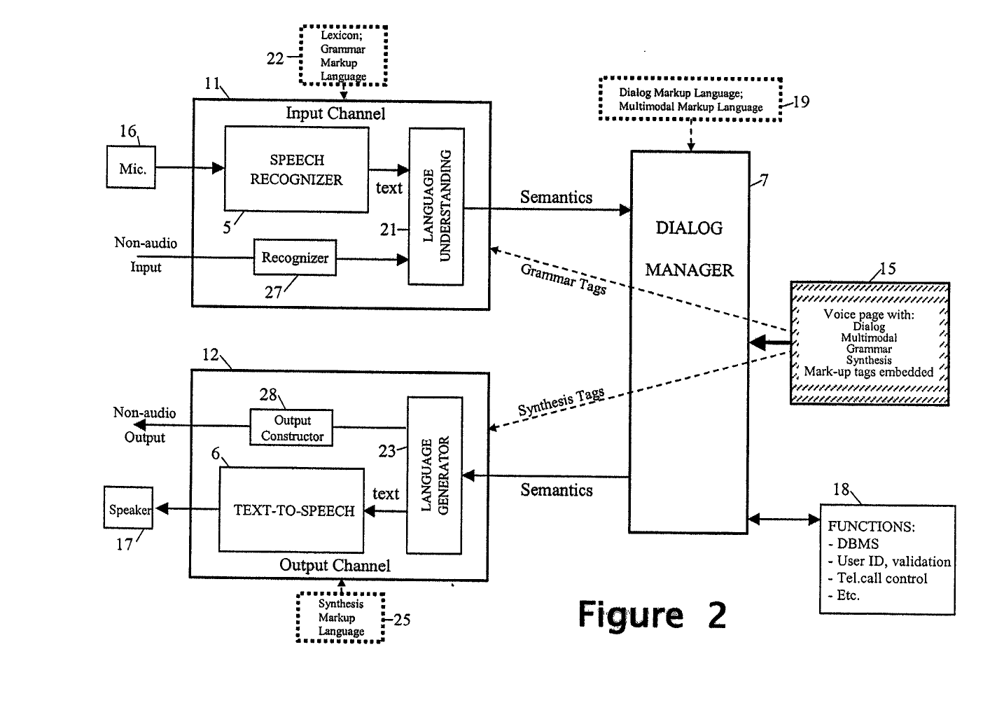

As well as location determination, FIGS. 2 to 5 also illustrate how the mobile entity requests a location-aware service provided by a service system 65. In the present examples, the request is depicted as being passed over a cellular mobile network (PLMN 30) to the service system 65. The PLMN is, for example, similar to that depicted in FIG. 6 with the service request being made using a data-capable bearer service of the PLMN. The service system 65 may be part of the PLMN itself or connected to it through a data network such as the public Internet. It should, however, be understood that infrastructure other than a cellular network may alternatively be used for making the service request; for example, the service request may be one made by an individual in their own home to a home server system, the person's location being determined by room location sensors and the service request being made over a home radio network. Furthermore, a service request can be made for an on-going service with individual service actions subsequently being effected without specific requests needing to be made.

The location-determining method illustrated in FIG. 7 uses an inertial positioning system 70 provided in the mobile entity 40A, this system 70 determining the displacement of the mobile entity from an initial reference position. When the mobile entity 40A wishes to invoke a location-aware service, it passes its current position to the corresponding service system 65 along with the service request 71. This approach avoids the need for an infrastructure to provide an external frame of reference; however, cost, size and long-term accuracy concerns currently make such systems unattractive for incorporation into mass-market handheld devices.

FIG. 8 shows two different location-determining methods both involving the use of local, fixed-position, beacons here shown as infra-red beacons IRD though other technologies, such as short-range radio systems (in particular, “Bluetooth” systems) may equally be used. The right hand half of FIG. 8 show a number of independent beacons 75 that continually transmit their individual locations. Mobile entity 40B is arranged to pick up the transmissions from a beacon when sufficiently close, thereby establishing its position to the accuracy of its range of reception. This location data can then be appended to a request 79 made by the mobile entity 40B to a location-aware service available from service system 65. A variation on this arrangement is for the beacons 75 to transmit information which whilst not directly location data, can be used to look up such data (for example, the data may be the Internet home page URL of a store housing the beacon 75 concerned, this home page giving the store location—or at least identity, thereby enabling look-up of location in a directory service).

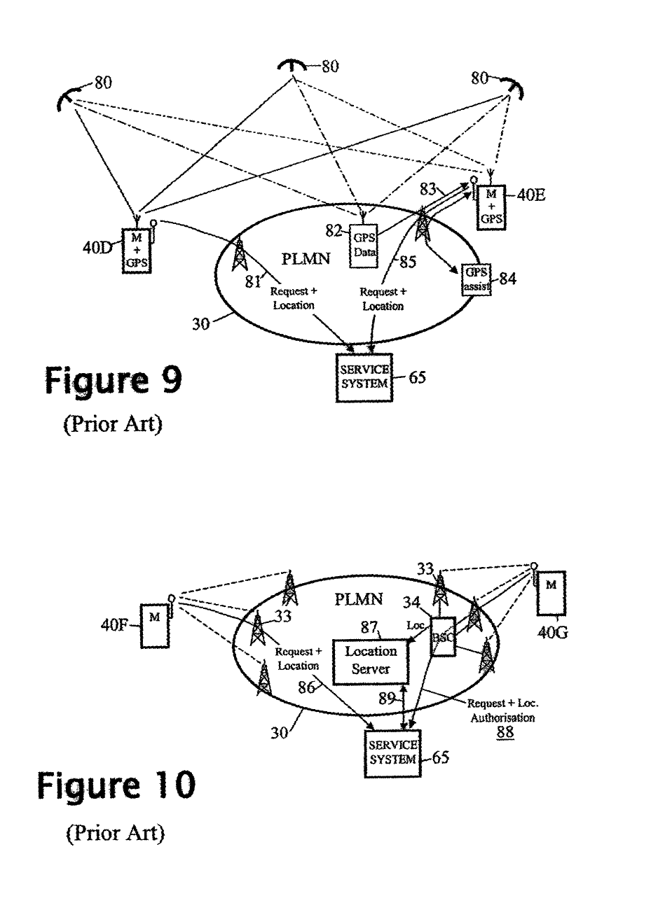

In the left-hand half of FIG. 8, the IRB beacons 74 are all connected to a network that connects to a location server 77. The beacons 74 transmit a presence signal and when mobile entity 40C is sufficiently close to a beacon to pick up the presence signal, it responds by sending its identity to the beacon. (Thus, in this embodiment, both the beacons 74 and mobile entity 40C can both receive and transmit IR signals whereas beacons 75 only transmit, and mobile entity 40B only receives, IR signals). Upon a beacon 74 receiving a mobile entity's identity, it sends out a message over network 76 to location server 77, this message linking the identity of the mobile entity 40C to the location of the relevant beacon 74. Now when the mobile entity wishes to invoke a location-aware service provided by the service system 65, since it does not know its location it must include it's identity in the service request 78 and rely on the service system 65 to look up the current location of the mobile entity in the location server 77. Because location data is personal and potentially very sensitive, the location server 77 will generally only supply location data to the service system 65 after the latter has produced an authorizing token supplied by the mobile entity 40B in request 78. It will be appreciated that whilst service system 65 is depicted as handling service requests form both types of mobile entity 40B and 40C, separate systems 65 may be provided for each mobile type (this is likewise true in respect of the service systems depicted in FIGS. 9 and 10).

FIG. 9 depicts several forms of GPS location-determining system. On the left-hand side of FIG. 9, a mobile entity 40D is provided with a standard GPS module and is capable of determining the location of entity 40D by picking up signals from satellites 80. The entity 40D can then supply this location when requesting, in request 81, a location-aware service from service system 65.

The right-hand side of FIG. 9 depicts, in relation to mobile entity 40E, two ways in which assistance can be provided to the entity in deriving location from GPS satellites. Firstly, the PLMN 30 can be provided with fixed GPS receivers 82 that each continuously keep track of the satellites 80 visible from the receiver and pass information in messages 83 to local mobile entities 80E as to where to look for these satellites and estimated signal arrival times; this enables the mobile entities 80E to substantially reduce acquisition time for the satellites and increase accuracy of measurement (see “Geolocation Technology Pinpoints Wireless 911 calls within 15 Feet” Jul. 1, 1999 Lucent Technologies, Bell Labs). Secondly, as an alternative enhancement, the processing load on the mobile entity 40E can be reduced and encoded jitter removed using the services of network entity 84 (in or accessible through PLMN 30).

One the mobile unit 40E has determined its location, it can pass this information in request 85 when invoking a location-aware service provided by service system 65.

FIG. 10 depicts two general approaches to location determination from signals present in a cellular radio infrastructure. Beyond current basic cell ID (and therefore approximate location) which is known both to the mobile entity and the network, it is possible to get a more accurate fix by measuring timing and/or directional parameters between the mobile entity and multiple BTSs 33, these measurement being done either in the network or the mobile entity (see, for example, International Application WO 99/04582 that describes various techniques for effecting location determination in the mobile and WO 99/55114 that describes location determination by the mobile network in response to requests made by location-aware applications to a mobile location center—server—of the mobile network).

The left-hand half of FIG. 10 depicts the case of location determination being done in the mobile entity 40F by, for example, making Observed Time Difference (OTD) measurements with respect to signals from BTSs 33 and calculating location using a knowledge of BTS locations. The location data is subsequently appended to a service request 86 sent to service system 65 in respect of a location-aware service. The calculation load on mobile entity 40F could be reduced and the need for the mobile to know BTS locations avoided, by having a network entity do some of the work. The right-hand half of FIG. 10 depicts the case of location determination being done in the network, for example, by making Timing Advance measurements for three BTSs 33 and using these measurements to derive location (this derivation typically being done in a unit associated with BSC 34). The resultant location data is passed to a location server 87 from where it can be made available to authorised services. As for the mobile entity 40C in FIG. 8, when the mobile entity 40G of FIG. 10 wishes to invoke a location-aware service available on service system 65, it sends a request 89 including an authorisation token and its ID (possible embedded in the token) to the service system 65; the service system then uses the authorisation token to obtain the current location of the mobile entity 40G from the location server 87.

In the above examples, where the mobile entity is responsible for determining location, this will generally be done only at the time the location-aware service is being requested. Where location determination is done by the infrastructure, it may be practical for systems covering only a limited number of users (such as the system illustrated in the left-hand half of FIG. 7 where a number of infrared beacons 74 will cover a generally fairly limited) for location-data collection to be done whenever a mobile entity is newly detected by an IRB, this data being passed to location server 77 where it is cached for use when needed. However, for systems covering large areas with potentially a large number of mobile entities, such as the FIG. 10 system, it is more efficient to effect location determination as and when there is a perceived need to do so; thus, location determination may be triggered by the location server 87 in response to the service request 88 from the mobile entity 40G or the mobile entity may, immediately prior to making request 88, directly trigger BSC 34 to effect a location determination and feed the result to location server 87.

Further with respect to the location servers 77, 87, whilst access authorisation by location-aware services has been described as being through authorisation tokens supplied by the mobile entities concerned, other authorisation techniques can be used. In particular, a location-aware service can be prior authorised with the location server in respect of particular mobile entities; in this case, each request from the service for location data needs only to establish that the request comes from a service authorised in respect of the mobile entity for which the location data is requested.

As already indicated, FIGS. 7 to 10 depict only some examples of how location determination can be achieved, there being many other possible combinations of technology used and where in the system the location-determining measurements are made and location is calculated, stored and used. Thus, the location-aware service may reside in the mobile entity whose location is of interest, in a network-connected service system 65 (as illustrated or in a home server system), or even in another mobile entity. Furthermore, whilst in the examples of FIGS. 7 to 10, invocation of the location-aware service has been by the mobile entity whose location is of interest, the nature of the location-aware service may be such that it is invoked by another party (including, potentially, the PLMN itself). In this case, unless the invoking party already knows the location of he mobile entity and can pass this information to the location-aware service (which may, for example, may be situation where the PLMN invokes the service), it is the location-aware service that is responsible for obtaining the required location data, either by sending a request to the mobile entity itself or by requesting the data from a location server. Unless the location server already has the needed information in cache, the server proceeds to obtain the data either by interrogating the mobile entity or by triggering infrastructure elements to locate the mobile. For example, where a location-aware service running on service system 65 in FIG. 10 needs to find the location of mobile 40G, it could be arranged to do so by requesting this information from location server 87 which in turn requests the location data from the relevant BSC, the latter then making the necessary determination using measurements from BTSs 33.

Although in the foregoing, the provision of location data through the mobile radio infrastructure to the mobile entity has been treated as a service effected over a data-capable bearer channel, it may be expected that as location data becomes considered a basic element of mobile radio infrastructure services, provision will be made in the relevant mobile radio standards for location data to be passed over a signalling channel to the mobile entity.

1. A system for enabling verbal communication on behalf of a local entity with a nearby user, the system comprising:
location determining means for determining the location of the user,
comparison means for comparing the location of the user with the known locations of entities having associated voice services, these voice services being separately hosted from the entities themselves;
a communications infrastructure;
audio output means operatively connected to the communication infrastructure and either forming part of equipment carried by the user or located in the locality of said local entity;
a voice service arrangement for providing said voice service, the voice service arrangement being connected to said communications infrastructure; and
service initiation means, responsive to the comparison means determining that the user is close to a said entity, to initiate, automatically or under user control, voice service delivery by the voice service arrangement via the communications infrastructure and
the audio output means with the voice service acting as voice proxy for the local entity; the audio output means comprising multiple sound output devices spaced from the local entity, and means for controlling their sound output such that output from the voice service appears to the user to emanate from said local entity.

2. A system according to claim 1, wherein the comparison means is separate from any equipment carried by the user, the service initiation means comprising:
means responsive to the comparison means determining that the user is close to a said entity, to send contact data for the voice service to the user; and
means, provided in user equipment intended carried by the user, for receiving the contact data and for enabling the user to contact the voice service arrangement using the contact data in order to initiate voice service delivery.

3. A system according to claim 1, wherein the comparison means is separate from any equipment carried by the user and the voice service arrangement comprises storage means for storing voice service content, and a voice browser for interpreting voice service content in respect of multiple different voice services for which content is stored by the storage means, the service initiation means being responsive to the comparison means determining that the user is close to a said entity, to pass contact data for the corresponding voice service to the voice browser of the voice service arrangement.

4. A system according to claim 1, further comprising user equipment adapted to communicate with the communications infrastructure over wireless means, the comparison means being separate from the user equipment and the service initiation means being responsive to the comparison means determining that the user is close to a said entity, to pass contact data for the user equipment to the voice service arrangement to enable the latter to initiate contact with the user over the communications infrastructure.

5. A system according to claim 1, further comprising user equipment adapted to communicate with the communications infrastructure over wireless means, at least the comparison means and the service initiation means being provided in the user equipment, the service initiation means being responsive to the comparison means determining that the user is close to a said entity, to contact the voice service arrangement over the communications infrastructure.

6. A system according to claim 1, further comprising audio input means operatively connected to the communications infrastructure and either forming part of equipment carried by the user, or located in the locality of said local entity, the audio input and output means together enabling a user to interact with the voice service through spoken dialog with voice input by the user through the audio input means and voice output to the user through the audio output means.

7. A system according to claim 6, wherein in said dialog the entity is represented in first person terms through the voice service.

8. A system according to claim 6, wherein both the audio input and output means form part of the user equipment carried by the user, the user equipment being operative to exchange said voice input and voice output with the voice service as voice signals passed across the communications infrastructure.

9. A system according to claim 6, wherein both the audio input and output means are located in the locality of said entity apart from the user equipment, the voice service arrangement being operative to exchange said voice input and voice output with the audio input and output devices as voice signals passed across the communications infrastructure.

10. A system according to claim 6, wherein the audio input means forms part of equipment carried by the user and the audio output means is located in the locality of said entity apart from the user equipment, the voice service arrangement being arranged to exchange said voice input and voice output with the audio input and output devices as voice signals across the communications infrastructure.

11. A system according to claim 1, wherein said multiple sound output devices are headphones worn by the user, the location of the voice service sound output in the audio field generated by the headphones being controlled to take account of the relative positions of the user and entity and rotations of the user's head.

12. A system according to claim 1, wherein said multiple sound output devices are loudspeakers associated with the locality of the entity rather than with the user and connected with the voice service through a communications infrastructure., the sound output from the loudspeakers being controlled in dependence on the relative positions of the user and entity.

13. A system according to claim 6, wherein the voice service arrangement comprises:
a voice page server for serving voice pages in the form of text with embedded voice markup tags; and
a voice browser comprising:
a speech recognizer for carrying out speech recognition of user voice input received as voice signals;
a dialog manager for effecting dialog control on the basis of output from the speech recognizer and pages served by the voice page server; and
a text-to-speech converter operative to convert voice pages into voice output signals under the control of the dialog manager.

14. A system according to claim 8, wherein the user equipment comprises a mobile phone providing the said audio input and output means, with wireless communication means of the mobile phone serving for the transfer of voice service input and output to and from the said audio input and output means.

15. A system according to claim 8, wherein the voice service arrangement comprises:
a voice page server for serving voice pages in the form of text with embedded voice markup tags; and
a voice browser comprising:
a speech recognizer for carrying out speech recognition of user voice input received as voice signals;
a dialog manager for effecting dialog control on the basis of output from the speech recognizer and pages served by the voice page server; and
a text-to-speech converter operative to convert voice pages into voice output signals under the control of the dialog manager;
the user equipment comprising a mobile phone providing said audio input and output means, with wireless communication means of the mobile phone serving for the transfer of voice service input and output to and from the said audio input and output means.

16. A system according to claim 15, wherein the voice browser is not part of the user's equipment, the service initiation means being responsive to the comparison means determining that the user is close to a said entity, to pass contact data for the voice service, in the form of a URL, to the user's equipment, the user equipment being operative to pass the contact data to the voice browser via a data-capable bearer circuit set up by the mobile phone through the communications infrastructure, and the voice browser being operative to use the contact data to contact the voice page server and being further operative to establish a voice circuit with the mobile phone for the exchange of voice input and/or output between the user and voice browser.

17. A system according to claim 15, wherein the voice browser is not part of the user's equipment, the service initiation means being responsive to the comparison means determining that the user is close to a said entity, to pass contact data for the voice service, in the form of a URL, to the user's equipment, the user equipment being operative to pass the contact data to the voice browser via a data-capable bearer circuit set up by the mobile phone through the communications infrastructure, and the voice browser being operative to use the contact data to access the voice page server and to thereafter use the data-capable bearer circuit for voice input and/or output between the user and voice browser using a packetized voice protocol.

18. A system according to claim 15, wherein the voice browser is part of the user's equipment, the service initiation means being responsive to the comparison means determining that the user is close to a said entity, to pass contact data for the voice service, in the form of a URL, to the user's equipment, the voice browser being operative to use the contact data passed to the equipment to access the voice page server via a data-capable bearer circuit set up by the mobile phone through the communications infrastructure for the exchange of text based input and/or output between the voice browser and voice page server.

19. A system according to claim 15, wherein the voice browser is not part of the user's equipment, the service initiation means being responsive to the comparison means determining that the user is close to a said entity, to pass contact data for the voice service, in the form of a URL, directly to the voice browser together with information for contacting the user's equipment, the voice browser being arranged to contact the user on the mobile phone using a voice circuit or data connection that is then used for voice input/or and output between the user and voice browser.

20. A system according to claim 1, wherein the communications infrastructure is a proprietary-space local wireless network hosting the voice service arrangement, the local entity being located in the proprietary-space concerned.

21. A system according to claim 8, wherein the communications infrastructure is a proprietary-space local wireless network hosting the voice service arrangement, the local entity being located in the proprietary-space concerned and the user equipment comprising a wireless headset.

22. A system according to claim 20, wherein said audio output means comprises headphones worn by the user, the location of the voice service sound output in the audio field generated by the headphones being controlled to take account of the relative positions of the user and entity and rotations of the user's head such that the sound output appears to be originating from said local entity.

23. A system according to claim 1, wherein the location determining means and the comparison means are arranged to operate on an on-going basis.

24. A method according to claim 1, wherein the location determining means and the comparison means are arranged to operate on a once-off basis as requested by the user.

25. A system according to claim 1, wherein the voice service arrangement is operative to connect a user newly contacting the voice service associated with said entity, into a session with any other users currently using the voice service in respect of the same local entity such that all users at least hear the voice output of the voice service.

26. A system according to claim 25, wherein the voice service arrangement is so arranged that voice input from a user is not broadcast to other users joined in the same session unless that input is selected for handling by the voice service.

27. A system according to claim 1, wherein the voice service arrangement is operative to connect a user newly contacting the voice service into a session with any other users currently using the voice service in respect of the same local entity and other entities that have been logically associated with that entity, the voice inputs and outputs to and from the voice service being made available to all such users.

28. A system according to claim 1, further comprising functionality associated with the local entity and arranged to be controlled by control data passed to it from the voice service.

29. A system according to claim 28, wherein said functionality includes a mouth-like feature movable by in dependence on the control data from the voice service whereby to cause operation of the mouth-like feature in synchronism with voice output from the voice service.

30. A system according to claim 1, further comprising means for sensing the position of the user relative to the entity, and means for passing corresponding position data to the voice service, the voice service being operative to condition its output in dependence on the user's sensed position.

31. A system according to claim 1, further comprising means for sensing the orientation of the user relative to the entity, and means for passing corresponding orientation data to the voice service, the voice service being operative to condition its output in dependence on the user's sensed orientation.

32. A system according to claim 1, further comprising means for sensing the line of approach of the user relative to the entity, and means for passing corresponding line-of approach data to the voice service, the voice service being operative to condition its output in dependence on the user's line of approach.

33. A method of voice communication concerning a local entity wherein:
(a) the location of a user is determined and compared with the known locations of entities having associated voice services, these voice services being separately hosted from the entities themselves;
(b) upon the user being determined to be close to a said entity, contact is initiated between the user and the voice service associated with the local entity; and
(c) the user interacts with the voice service with the latter acting as voice proxy for the local entity, voice output from the service being through audio output devices spaced from the local entity but controlled such that the service output appears to the user to emanate from that entity.

34. A method according to claim 33, wherein step (a) is effected by a service system separate from any equipment carried by the user; the service system upon determining that the user is close to a said entity, effecting step (b) by passing contact data for the voice service to the user whereby to enable the user to contact the voice service.

35. A method according to claim 33, wherein step (a) is effected by a service system separate from any equipment carried by the user, the service system upon determining that the user is close to a said entity, effecting step (b) by passing contact data for the voice service to a voice browser of the service system or communications infrastructure whereby to enable the voice browser to contact the voice service on behalf of the user.

36. A method according to claim 33, wherein step (a) is effected by a service system separate from any equipment carried by the user, the service system upon determining that the user is close to a said entity, effecting step (b) by passing user contact information to the voice service whereby to enable the latter to initiate contact with the user.

37. A method according to claim 33, wherein step (a) is effected by equipment carried by the user which, upon determining that the user is close to a said entity, effects step (b) by contacting the voice service.

38. A method according to claim 33, wherein in step (c) the user and voice service interact through spoken dialog with both voice input by the user and voice output by the service.

39. A method according to claim 38, wherein in said dialog the entity is represented in first person terms through the voice service.

40. A method according to claim 33, wherein step (c) involves voice input by the user and voice output by the service with both voice input and voice output being carried across the wireless network between the voice service and sound input and output devices forming part of the user's equipment.

41. A method according to claim 33, wherein step (c) involves voice input by the user and voice output by the service with both voice input and voice output being exchanged with the user by local sound input and output devices that are associated with the locality of the entity rather than with the user and are connected with the voice service through a communications infrastructure.

42. A method according to claim 33, wherein step (c) involves voice input by the user and voice output by the service, voice input being carried across the wireless network to the voice service from a sound input device forming part of the user's equipment, and voice output being through at least one local sound output device that is associated with the locality of the entity rather than with the user and is connected with the voice service through a communications infrastructure.

43. A method according to claim 33, wherein said multiple sound output devices are headphones worn by the user, the location of the voice service sound output in the audio field generated by the headphones being controlled to take account of the relative positions of the user and entity and rotations of the user's head.

44. A method according to claim 33, wherein said multiple sound output devices are loudspeakers associated with the locality of the entity rather than with the user and connected with the voice service through the communications infrastructure, the sound output from the loudspeakers being controlled in dependence on the relative positions of the user and entity.

45. A method according to claim 33, wherein the voice service is effected by the serving of voice pages in the form of text with embedded voice markup tags to a voice browser, the voice browser interpreting these pages and carrying out speech recognition of user voice input, text to speech conversion to generate voice output, and dialog management; the voice browser being disposed between a voice page server and the user.

46. A method according to claim 33, wherein the user equipment includes a mobile phone, step (c) involving use of the mobile phone to transfer voice service input and output to and from the user.

47. A method according to claim 33, wherein:
the voice service is effected by the serving of voice pages in the form of text with embedded voice markup tags to a voice browser, the voice browser interpreting these pages and carrying out speech recognition of user voice input, text to speech conversion to generate voice output, and dialog management; the voice browser being disposed between a voice page server and the user; and
the user has equipment including a mobile phone, step (c) involving use of the mobile phone to transfer voice service input and output to and from the user.

48. A method according to claim 48, wherein the voice browser is not part of the user's equipment and in step (b) contact data for the voice service, in the form of a URL, is passed to the user's equipment from where it is passed using the mobile phone via a data-capable bearer service of the mobile-phone wireless network, to the voice browser, the voice browser calling the user on the mobile phone using a voice circuit that is then used in step (c) for voice input and/or output between the user and voice browser.

49. A method according to claim 48, wherein the voice browser is not part of the user's equipment and in step (b) contact data for the voice service, in the form of a URL, is passed to the user's equipment from where it is passed using the mobile phone, via a data-capable bearer service of the mobile-phone wireless network, to the voice browser; the data-capable bearer service being subsequently used in step (c) for voice input and/or output between the user and voice browser using a packetized voice protocol.

50. A method according to claim 48, wherein the voice browser is part of the user's equipment and in step (b) contact data for the voice service, in the form of a URL, is passed to the user's equipment, the voice browser using this contact data in step (b) to access, via a data-capable bearer service of the mobile-phone wireless network, the voice page server; the data-capable bearer service being subsequently used in step (c) for passing text based input and/or output between the voice browser and voice page server.

51. A method according to claim 48, wherein the voice browser is not part of the user's equipment and in step (b) contact data for the voice service, in the form of a URL, is passed directly to the voice browser together with information for contacting the user's equipment, the voice browser contacting the user on the mobile phone using a voice circuit or data connection that is then used in step (c) for voice input/or and output between the user and voice browser.

52. A method according to claim 33, wherein a proprietary-space local wireless network hosts the voice service, the local entity being located in the proprietary-space concerned.

53. A method according to claim 52, wherein the user has a wireless headset which in step (c) is used for exchanging voice input and output with the voice service.

54. A method according to claim 33, wherein the carrying out of step (b) is subject to user approval at the time.

55. A method according to claim 33, wherein location determination and comparison with the known location of entities having associated voice services, is effected in step (a) on an on-going basis.

56. A method according to claim 33, wherein location determination and comparison with the known location of entities having associated voice services, is effected in step (a) on a once-off basis as requested by the user.

57. A method according to claim 33, wherein in step (b) the identity of the user is sent to the voice service and used by the latter to look up user profile data which is then used to customise the voice service to the user.

58. A method according to claim 33, wherein the user on being placed in contact the voice service in step (b) is joined into a session with any other users currently using the voice service in respect of the same local entity such that all users at least hear the voice output of the voice service.

59. A method according to claim 58, wherein voice input from a user is not broadcast to other users joined in the same session unless that input is selected for handling by the voice service.

60. A method according to claim 33, wherein the user on being placed in contact the voice service in step (b) is joined into a session with any other users currently using the voice service in respect of the same local entity and other entities that have been logically associated with that entity, the voice inputs and outputs to and from the voice service being made available to all such users.

61. A method according to claim 33, wherein the local entity has associated functionality that is controlled by control data passed from the voice service via a network connection or short-range link between the user equipment and said associated functionality of the local entity.

62. A method according to claim 61, wherein the local entity has an associated mouth-like feature movable by said functionality, the control data from the voice service being used to cause operation of the mouth-like feature in synchronism with voice output from the voice service.

63. A method according to claim 33, wherein the voice service provided to a user is dependent on the user's position, orientation or line of approach relative to the entity.
